(19) United States
(12) Patent Application Publication
(10) Pub. No.: US 2025/0230893 A1
(43) Pub. Date: Jul. 17, 2025

(54) Removable Cover

(71) Applicant: Specialty Products & Insulation, Chalotte, NC (US)

(72) Inventors: Thomas Salagaj, Wallingford, CT (US); Jonathan Morano, Milford, CT (US); Matthew Morano, Milford, CT (US)

(73) Assignee: Specialty Products & Insulation, Charlotte, NC (US)

(21) Appl. No.: 18/413,581

(22) Filed: Jan. 16, 2024

(51) Int. Cl. F16L 59/02; B32B 5/02; B32B 5/26

(52) U.S. Cl. CPC F16L 59/026; B32B 5/02; B32B 5/26; B32B 2260/023; B32B 2260/046; B32B 2262/101; B32B 2307/102; B32B 2307/304; B32B 2307/3065

(57) ABSTRACT

A removable cover includes a first jacket portion having a first jacket portion end. A first substrate portion is attached to the first jacket portion and has a first substrate portion end. The removable cover also includes a second jacket portion having a second jacket portion end. A second substrate portion is attached to the second jacket portion and has a second substrate portion end. The removable cover also has a compressive element attached to the first jacket portion and the second jacket portion. The first jacket portion end overlaps the second jacket portion end at a joint of a plurality of joints of the removable cover in a compressed state of the removable cover. The compressive element provides a compressive force on the joint in the compressed state.

### FIELD OF THE INVENTION

The present invention relates to a removable cover and, more particularly, to a removable cover for a coverable unit.

### BACKGROUND

Coverable units, such as heat exchangers, may require insulation systems for temperature and condensation control. Conventional insulation systems used for temperature and condensation control utilize a sealed layer or layers of insulation with additional layers of vapor barriers. These types of conventional insulation systems are permanent structures that must be destroyed and rebuilt when the coverable unit requires inspection or maintenance, which is costly and inefficient.

Some other conventional insulation systems use removable insulation blankets. These types of insulation systems, however, typically do not closely conform to the coverable unit or the coverable unit's piping, allowing large gaps for air and water vapor to be channeled between the back surface of the insulation facing the coverable unit and the coverable unit. This can allow the vapors to condense, leading to water seepage, frost, and corrosion under the insulation. Due to these potential issues, removable blankets are typically not a recommended method of insulation for low temperature applications.

### SUMMARY

A removable cover includes a first jacket portion having a first jacket portion end. A first substrate portion is attached to the first jacket portion and has a first substrate portion end. The removable cover also includes a second jacket portion having a second jacket portion end. A second substrate portion is attached to the second jacket portion and has a second substrate portion end. The removable cover also has a compressive element attached to the first jacket portion and the second jacket portion. The first jacket portion end overlaps the second jacket portion end at a joint of a plurality of joints of the removable cover in a compressed state of the removable cover. The compressive element provides a compressive force on the joint in the compressed state.

### BRIEF DESCRIPTION OF THE DRAWINGS

The invention will now be described by way of example with reference to the accompanying figures, of which:

FIG. 1 is a perspective view of an embodiment of a removable cover;

FIG. 2 is another perspective view of the removable cover of FIG. 1;

FIG. 3 is a top view of the removable cover of FIG. 1;

FIG. 4 is a perspective view of a back surface of a jacket of the removable cover of FIG. 1;

FIG. 5 is a plan view of a front surface of another jacket of the removable cover of FIG. 1;

FIG. 6 is a plan view of a back surface of the jacket of FIG. 5;

FIG. 7a is a plan view of a front surface of another jacket of the removable cover;

FIG. 7b is a plan view of a back surface of the jacket of FIG. 7a;

FIG. 8 is a sectional perspective view of a portion of the jackets of FIGS. 4, 5, and 7a;

FIG. 9 is a perspective view of an embodiment of a coverable unit;

FIG. 10 is a perspective view of the removable cover of FIG. 1 covering the coverable unit of FIG. 9 in a compressed state;

FIG. 11 is a cross-sectional view of the attachment of a first jacket portion attaching to a second jacket portion at a joint of the removable cover of FIG. 10; and

FIG. 12 is a cross-sectional view of a pipe of the coverable unit of FIG. 10 being covered by a part of the removable cover of FIG. 10.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein; rather, these embodiments are provided so that the present disclosure will convey the concept of the invention to those skilled in the art.

Throughout the drawings, only one, multiple, or all of a plurality of identical elements may be labeled in a figure for clarity of the drawings, but the detailed description of the element herein applies equally to each of the identically appearing elements in the figure if all elements are not labeled.

Throughout the specification various terms are used to describe the connections between various elements. The terms used to describe connections between various elements throughout the specification are defined as follows: (1) the term “fixedly attach”, or any iteration thereto, is intended to mean elements are attached to one another in a way that would cause them to be damaged if they are taken apart; and (2) the term “releasably attach”, or any iteration thereto, is intended to mean elements are attached to one another in a way that the attachment is secure but the elements are capable of being taken apart without either element sustaining any damage.

Throughout the specification, terms of approximation may be used. The terms of approximation used herein are defined as follows: (1) the term “approximately” is intended to mean within 10% of the described numerical value or the described numerical ends of the range; and (2) the term “smaller” is intended to mean that a size of an element or nonelement decreases from one state to another.

Throughout the specification, the term “edge” is used in reference to various elements. The term “edge”, and any iteration thereto, is intended to refer to a respective end portion of an element.

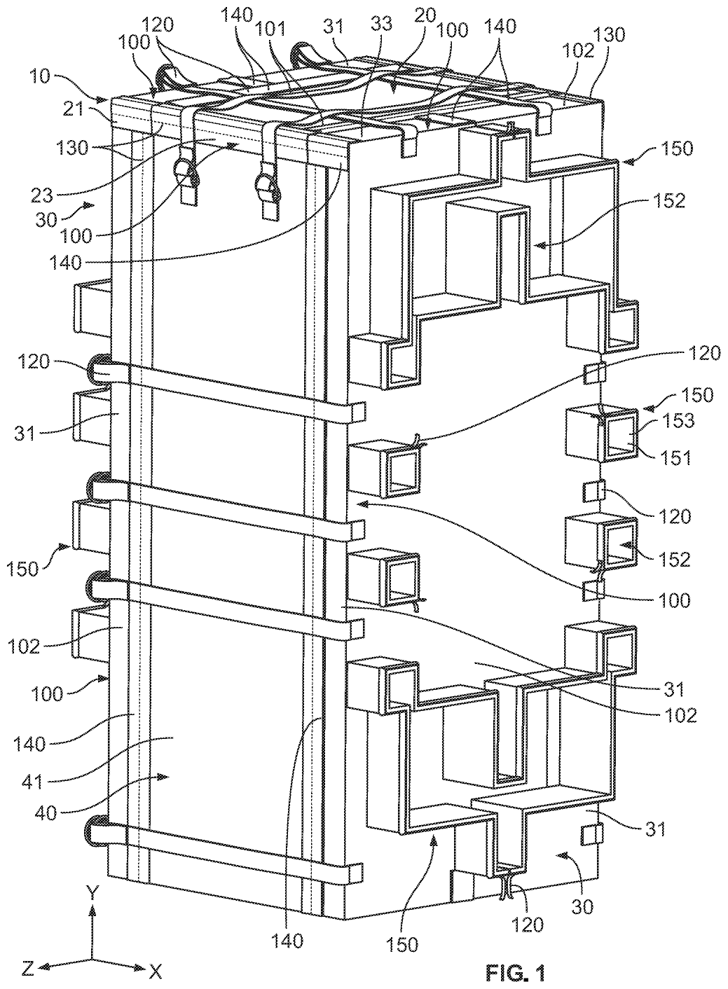

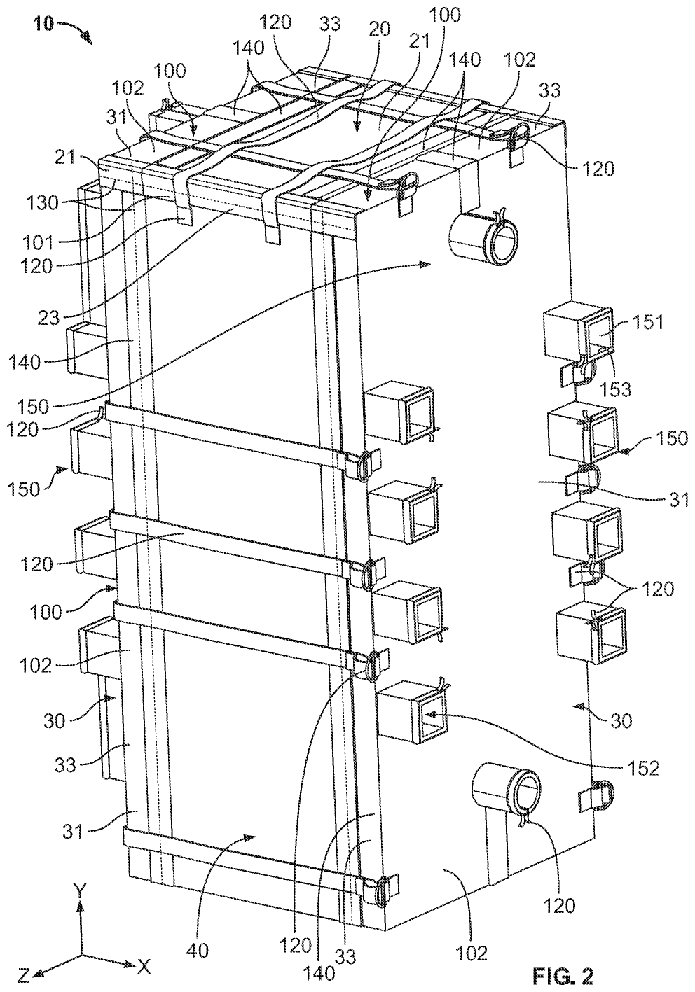

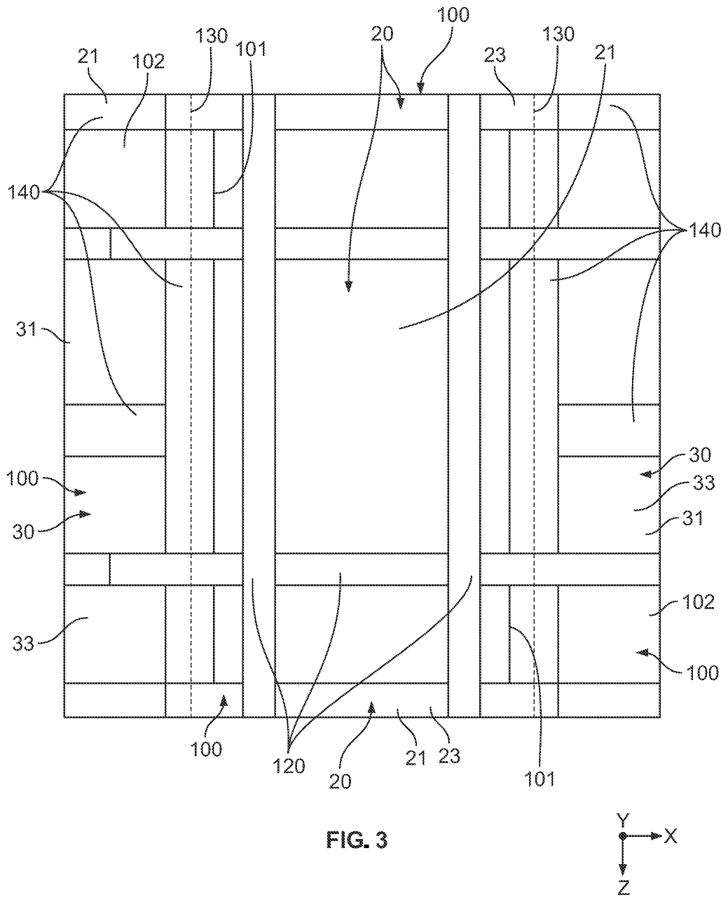

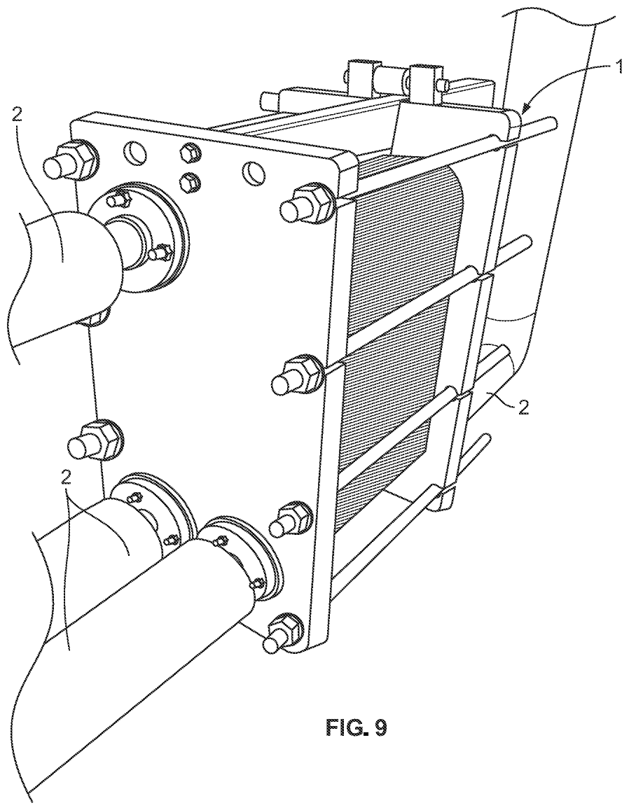

A removable cover 10 according to an embodiment of the invention is shown in FIGS. 1-3 and 10. The removable cover 10 can be used to cover various equipment for a number of possible applications including, for example, dampening sound, insulating, fireproofing, and/or adding fire resistance to the equipment. For example, the cover 10 can be used to insulate various heat exchangers or any other devices that would benefit from increased insulation. While the removable cover 10 can be used to cover various equipment, for ease of understanding, the removable cover 10 will be described with reference to a coverable unit 1 as shown in FIG. 9.

A coverable unit 1, as shown in FIG. 9, is an exemplary heat exchanger. The coverable unit 1 has an approximately rectangular shape. As shown in FIG. 9, the coverable unit 1 has heat exchanger plates and transfers heat from one medium to another. The coverable unit 1 also has a plurality of inlet and outlet pipes (hereinafter “CU Pipes” 2).

A coordinate system is provided in the Figures for ease of understanding the removable cover 10. The coordinate system comprises a vertical direction Y, a horizontal direction X perpendicular to the vertical direction Y, and a longitudinal direction Z. The longitudinal direction Z is perpendicular to the vertical direction Y and the horizontal direction X. These directional coordinates do not imply or require any particular orientation of the disclosed elements.

The removable cover 10 is now described with reference to FIGS. 1-8 and 10-12. The removable cover 10 according to an embodiment shown in FIGS. 1-3 and 10 comprises a top jacket 20, a protrusion jacket 30, and a nonprotrusion jacket 40. The removable cover 10 of the present embodiment, as shown in FIGS. 1-3, comprises one top jacket 20, two protrusion jackets 30, and two nonprotrusion jackets 40 to accommodate the approximately rectangular shape of the coverable unit 1. In other embodiments, the removable cover 10 may comprise any number and combination of the jackets 20,30,40 to cover the coverable unit 1, or a different shaped and/or sized coverable unit.

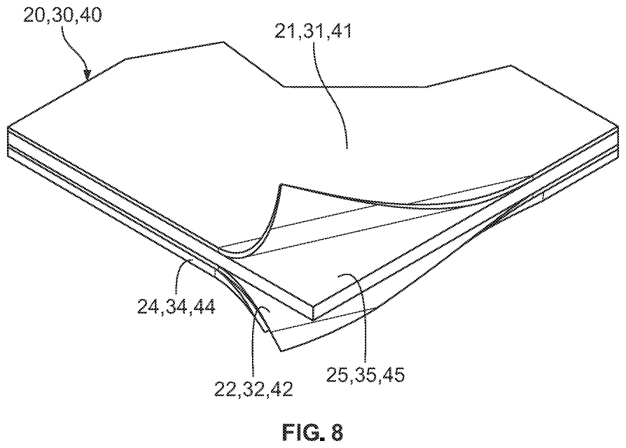

The jackets 20, 30, 40 of the removable cover 10 are formed of similar materials and share similar components. Each of the jackets 20, 30, 40, as shown in FIG. 8, may be formed of the same layers, but the jackets 20, 30, 40 have different and complementary components at their edges that permit the jackets 20, 30, 40 to fit together to form the removable cover 10.

The jackets 20,30,40 are a fabric material. In the present embodiment, the jackets 20,30,40 are a silicone impregnated fiberglass cloth. In various other embodiments, the jackets 20,30,40 may be any fabric material or any other material known to those of ordinary skill in the art that allows the elements to function as described herein.

As shown in FIG. 8, the jackets 20,30,40 of the present embodiment are formed of two sheets of the fabric material, each sheet being a respective jacket front surface 21,31,41 and a respective jacket back surface 22,32,42. In various other embodiments, the jackets 20,30,40 may be formed of any number of sheets of fabric material or any other material known to those of ordinary skill in the art that allows the elements to function as described herein. In the present embodiment, jackets 20,30,40 are formed by the attachment of the respective jacket front surface 21,31,41 to the respective jacket back surface 22,32,42, for example, with a seam. In various other embodiments the respective jacket front surface 21,31,41 and the respective jacket back surface 22,32,42 may be fixedly attached or removably attached to one another in anyway known by one of ordinary skill in the art that allows the elements to function as described herein.

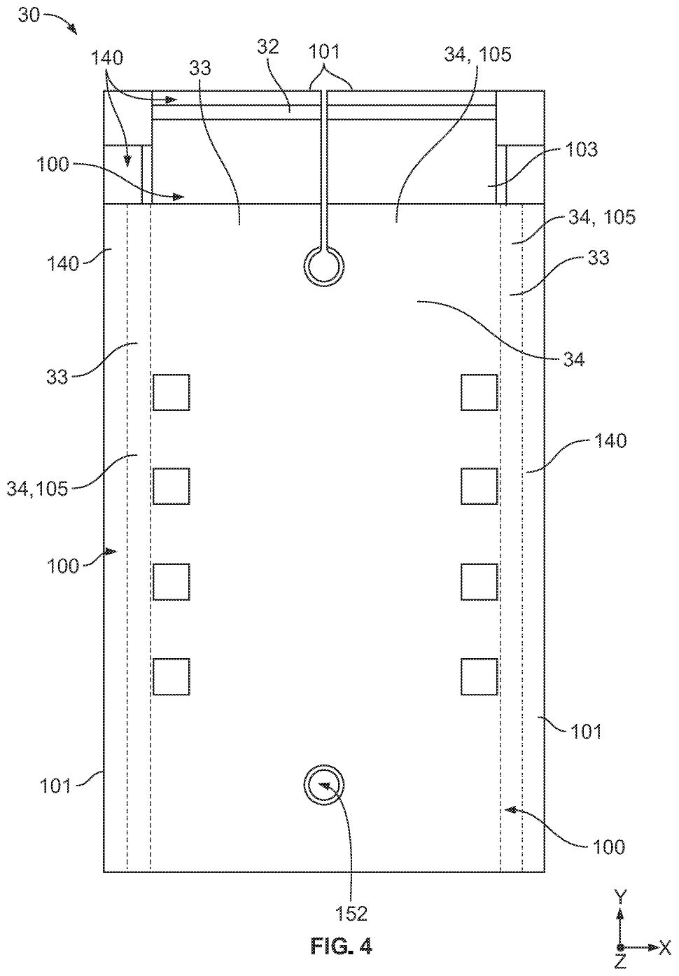

As shown in FIGS. 4, 6, and 7b, the jacket substrates 24,34,44 are attached to a respective jacket back surface 22,32,42 with an adhesive. In various other embodiments, the jacket substrates 24,34,44 may be removably attached or fixedly attached to the jacket front surfaces 21,31,41 and/or the jacket back surfaces 22,32,42 by a chemical weld, a seam, or any other way known by one of ordinary skill in the art that allows the elements to function as described herein. The jacket substrates 24,34,44 are an insulative material. In the present embodiment the jacket substrates 24,34,44 are a closed-cell elastomeric foam. In various other embodiments the jacket substrates 24,34,44 may be any insulative material, sound dampening material, fireproof material, and/or fire resistant material known to those of ordinary skill in the art that allows the elements to function as described herein. For example, in the various other embodiments, the jacket substrates 24,34,44 may be a mass-loaded vinyl, a woven fiberglass, or a stainless steel foil.

As further shown in FIG. 8, the jackets 20,30,40 may have a respective jacket enclosed layer 25,35,45. The jacket enclosed layers 25,35,45 of the present embodiment are enclosed inside of the respective jacket 20,30,40 between the respective jacket front surface 21,31,41 and the respective jacket back surface 22,32,42 when the respective jacket front surface 21,31,41 and the respective jacket back surface 22,32,42 are attached together as described above. The jacket enclosed layer 25,35,45 is an insulative material. In the present embodiment the jacket enclosed layers 25,35,45 are a closed-cell elastomeric foam. In various other embodiments, the jacket enclosed layers 25,35,45 may be any insulative material, sound dampening material, fireproof material, and/or fire resistant material known to those of ordinary skill in the art that allows the elements to function as described herein. For example, in the various other embodiments, the jacket enclosed layers 25,35,45 may be a mass-loaded vinyl, a woven fiberglass, or a stainless steel foil. In another embodiment, the jacket enclosed layers 25,35,45 are omitted.

The components of the individual jackets 20,30,40 will now be described in greater detail.

The top jacket 20, shown in FIGS. 1-3, and 7a-8 comprises a front top jacket surface 21, a back top jacket surface 22 opposite the front top jacket surface 21 in the vertical direction Y, a plurality of top jacket edges 23, a top jacket substrate 24, and a top jacket enclosed layer 25. Each top jacket edge 23 of the plurality of top jacket edges 23 is either a first jacket portion 100 or a second jacket portion 110 described in more detail below.

As shown in FIGS. 1-2, 4, 8, and 10, the protrusion jacket 30 comprises a front protrusion jacket surface 31, a back protrusion jacket surface 32 opposite the front protrusion jacket surface 31 in the longitudinal direction Z, a plurality of protrusion jacket edges 33, a protrusion jacket substrate 34, and a protrusion jacket enclosed layer 35. Each protrusion jacket edge 33 of the plurality of protrusion jacket edges 33, in the shown embodiment, is the first jacket portion 100 described in more detail below.

As shown in FIGS. 1-2, 5-6 and 10, the nonprotrusion jacket 40 comprises a front nonprotrusion jacket surface 41, a back nonprotrusion jacket surface 42 opposite the front nonprotrusion jacket surface 41 in the longitudinal direction Z, a plurality of nonprotrusion jacket edges 43, a nonprotrusion jacket substrate 44, and a nonprotrusion jacket enclosed layer 45. Each nonprotrusion jacket edge 43 of the plurality of nonprotrusion jacket edges 43, in the shown embodiment, is the second jacket portion 110 described in more detail below.

Respective elements of the jackets 20,30,40, namely the first jacket portion 100 and the second jacket portion 110, as well as the compressive element 120, the plurality of joints 130, the plurality of fasteners 140, and the plurality of protrusions 150, are now described with reference to FIGS. 1-8, and 10-12.

As shown in FIGS. 1-4 and 10, the first jacket portion 100 comprises a first jacket portion end 101, a first jacket portion front surface 102, a first jacket portion back surface 103 opposite the first jacket portion front surface 102 in the longitudinal direction Z (for the protrusion jacket 30) or the vertical direction Y (for the top jacket 20 and the plurality of protrusions 150), and a first substrate portion 105. As shown in FIGS. 1-2, 4, 7a, 10, and 12, the first jacket portion 100 is a portion of each protrusion 150 of the plurality of protrusions 150 and some or all of the respective jacket edges 23,33 of the jackets 20,30 as described above.

The first jacket portion 100, as shown in FIGS. 1-4 and 7a, is disposed on the jacket edges 23,33 as described above. The first jacket portion 100 of the present embodiment is a flexible flap that is disposed on the jackets 20,30 and may be attached, for example, with a seam. In another embodiment, the first jacket portion 100 is an integrated portion of the jackets 20,30.

As shown in FIGS. 1-2 and 10, the first jacket portion 100 is made of a fabric material. In the present embodiment, the first jacket portion 100 is a silicone impregnated fiberglass cloth. In various other embodiments the first jacket portion 100 may be any fabric material or any other material known to those of ordinary skill in the art that allows the elements to function as described herein. The first jacket portion 100 is formed of two sheets of a fabric material in the same way as the jackets 20,30,40 as described above, each sheet respectively being the first jacket portion front surface 102 and the first jacket portion back surface 103. In various other embodiments, the first jacket portion 100 may be formed of any number of sheets of fabric material or any other material known to those of ordinary skill in the art that allows the elements to function as described herein. The first jacket portion 100 of the present embodiment does not have an enclosed layer in the shown embodiment, but may in other embodiments like the jacket enclosed layers 25,35,45 as described above.

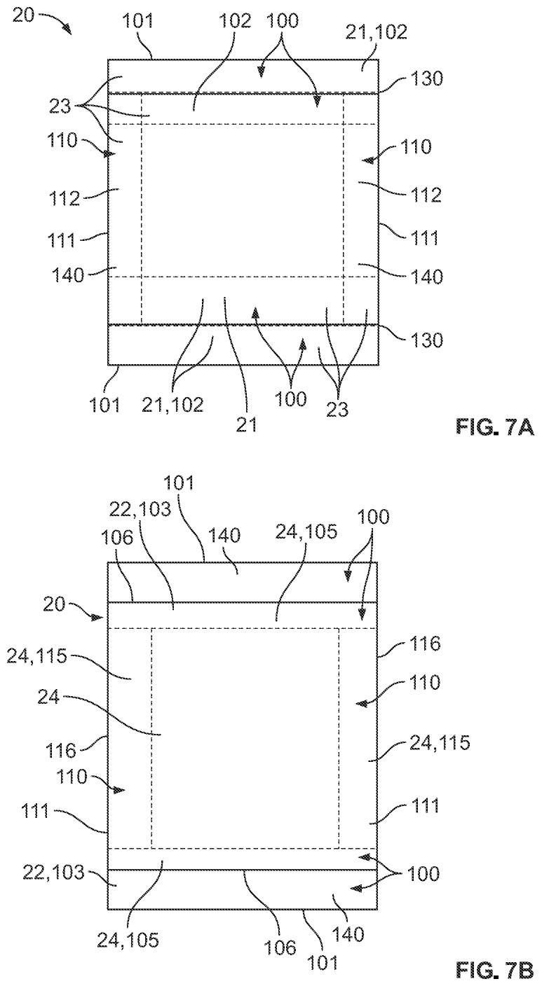

As shown in FIGS. 1-2, 4, 7a-7b, and 10, the first jacket portion 100 has multiple first jacket portion ends 101. Each first jacket portion end 101, as shown in FIGS. 4 and 7a-7b, is an edge of the first jacket portion 100. The plurality of fasteners 140 are attachable to the first jacket portion back surface 103 at the first jacket portion end 101 as described in more detail below. The compressive elements 120, as shown in FIGS. 1-3 and 10, are attachable to the first jacket portion front surface 102 at the first jacket portion end 101 as described in more detail below.

The first substrate portion 105, as shown in FIGS. 4 and 7b, has a first substrate portion end 106. The first substrate portion 105 is a portion of the respective jacket substrates 24,34 as described above and a protrusion substrate 153 as described in more detail below.

As shown in FIGS. 1-2, 5-6, and 7a-7b, the second jacket portion 110 comprises a second jacket portion end 111, a second jacket portion front surface 112, a second jacket portion back surface 113 opposite the second jacket front surface 112 in the longitudinal direction Z (for the nonprotrusion jacket 40) or the vertical direction Y (for the top jacket 20 and the plurality of protrusions 150), and a second substrate portion 115. The second jacket portion 110 is a portion of the jackets 20,40 at the jacket edges 23,43. In another embodiment the second jacket portion 110 is a flap that may be integrated with or attached to the jackets 20,40 at the jacket edges 23,43.

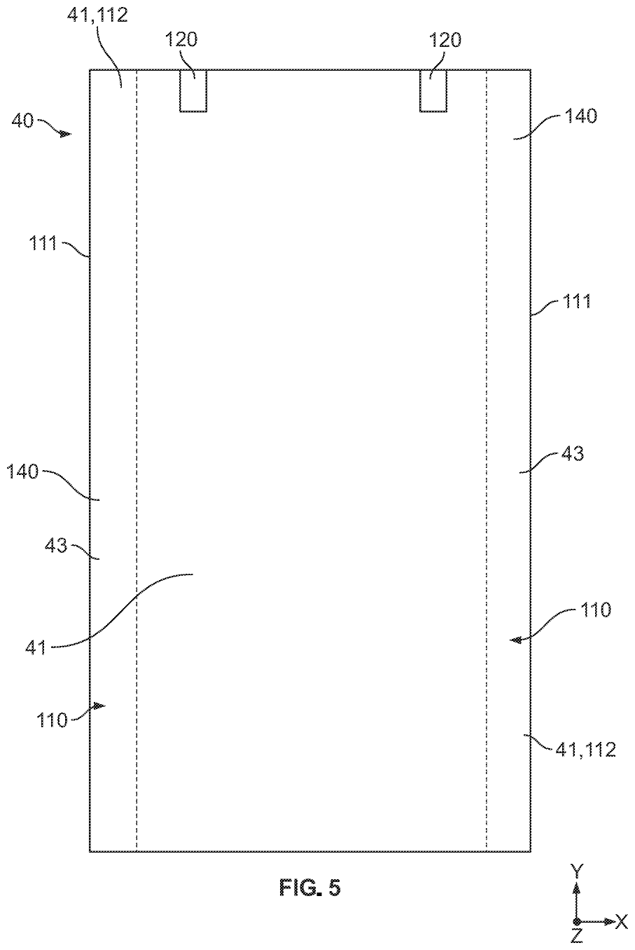

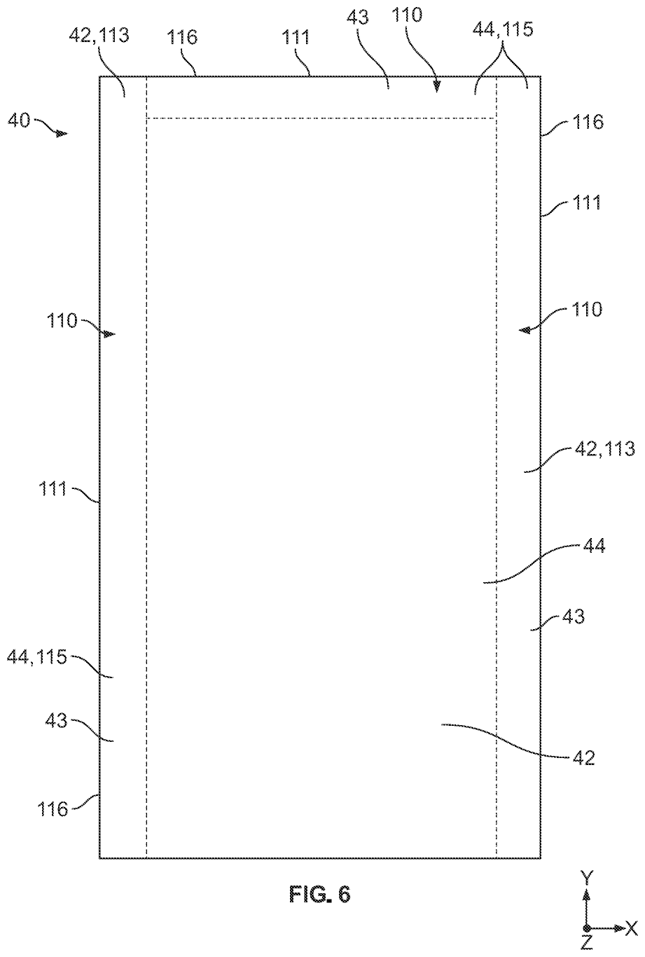

As shown in FIGS. 5 and 7a-7b, the second jacket portion 110 has multiple second jacket portion ends 111. In another embodiment, the second jacket portion 110 has any number of second jacket portion ends 111. Each second jacket portion end 111, as shown in FIGS. 5 and 7a-7b, is an edge of the second jacket portion 110. As shown in FIG. 5, the compressive elements 120 are attachable to the second jacket portion front surface 112 at the second jacket portion end 111 as described in more detail below. As further shown in FIGS. 5 and 7a, the plurality of fasteners 140 are attachable to the second jacket portion front surface 112 at the second jacket portion end 111. The second substrate portion 115, as shown in FIGS. 6 and 107b, has a second substrate portion end 116. The second substrate portion 115 is a portion of the respective jacket substrates 24,44 as described above and a protrusion substrate 153 as described in more detail below.

As shown in FIGS. 1-3, 5 and 10, the compressive element 120 is operable by a user to exert a compressive force on the jackets 20,30,40 and the coverable unit 1 as described in more detail below. The compressive element 120 is attachable to the first jacket portion 100, and the second jacket portion 110, for example, with a seam and/or a draw string connection. In various other embodiments, the compressive element 120 is attachable to the first jacket portion 100, and the second jacket portion 110 in any way known by one of ordinary skill in the art that allows the elements to function as described herein.

The compressive element 120, as shown in FIGS. 1-3, 5, and 10, is a cinch strap and/or a draw string. In various other embodiments, the compressive element 120 may be any type of device known by one of ordinary skill in the art that allows the user to exert a compressive force on: (1) the jackets 20,30,40 and the coverable unit 1 as described below; and (2) the plurality of protrusions 150 and the CU Pipes 2 as described below. As shown in FIGS. 1-3, 5, and 10, the cinch strap compressive element 120 attaches to the first substrate portion end 101 and the second substrate portion end 111. In another embodiment the cinch strap compressive element 120 attaches to anywhere on the first jacket portion 100 and the second jacket portion 110.

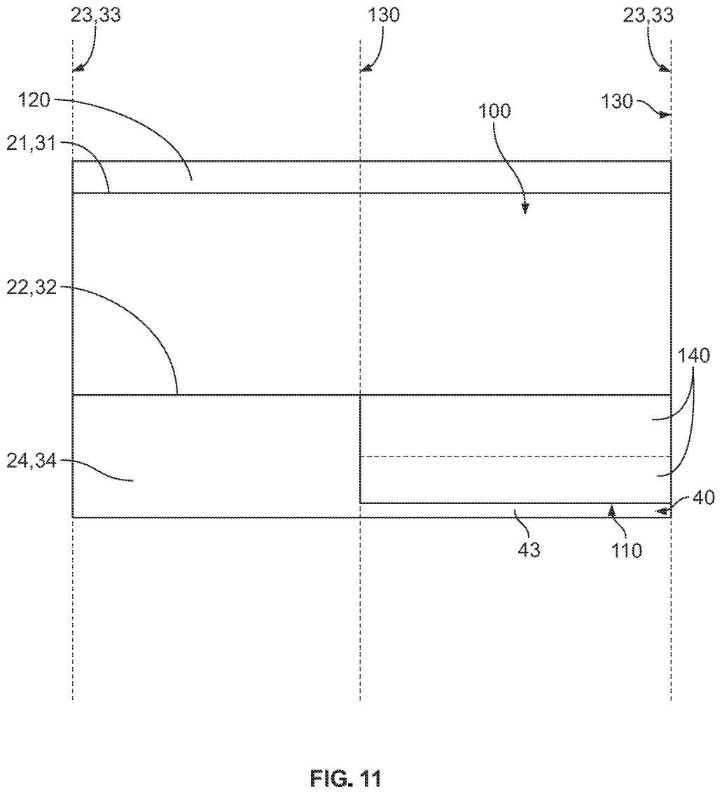

The plurality of joints 130 of the removable cover 10, as shown in FIGS. 1-3, and 10-12, are formed by the attachment of the jackets 20,30,40 to one another by their respective first jacket portions 100 and/or their second jacket portions 110. As shown in FIG. 11, every time the first jacket portion 100 is attached to the second jacket portion 110, as described in more detail below, the point at which the attachments are made is a respective joint 130 of the plurality of joints 130. Further, FIG. 11 only shows a respective joint 130 made by the attachment of the first jacket portions 100 of jackets 20,30 to the second jacket portions 110 of the nonprotrusion jackets 40. While other joints 130 made by the attachment of the first jacket portions 100 of the protrusion jackets 30 to the second jacket portions 110 of the top jacket 20 are not shown, the attachment depicted in FIG. 11 equally applies to the aforementioned attachments.

As shown in FIGS. 1-5 and 7a, the plurality of fasteners 140 removably attach the jackets 20,30,40 to one another via their respective first jacket portions 100 and/or their second jacket portions 110 at a respective joint 130 of the plurality of joints 130 as described in more detail below. In the present embodiment, a fastener 140 of the plurality of fasteners is attached to the first jacket portion 100, for example, with a seam. A complementary fastener 140 is attached to the second jacket portion 110, for example, with a seam. In various other embodiments the plurality of fasteners 140 can be removably attached or fixedly attached to the first jacket portion 100 and the second jacket portion 110 with any fastener know to one of ordinary skill in the art that allows the elements to function as described herein.

The plurality of fasteners 140 in the present embodiment are hook and loop fasteners. In various other embodiments, the plurality of fasteners 140 may be any other type of fastener known to those with ordinary skill in the art and capable of fastening the elements described herein. In another embodiment, the first jacket portion 100 and the second jacket portion 110 do not have the plurality of fasteners 140. In the embodiment without the plurality of fasteners 140, the first jacket portion 100 and the second jacket portion 110 are removably attached to one another without a fastener in any way known to one of ordinary skill in the art that allows the elements to function as described herein. The plurality of fasteners 140, as shown in FIGS. 1-3 and 10-11, are positioned underneath the compressive element 120. In another embodiment the plurality of fasteners 140 are positioned above the compressive element 120 or in any position relative to the compressive element 120 known by one of ordinary skill in the art that allows the elements to function as described herein.

In the present embodiment, each protrusion 150 of the plurality of protrusions 150 has an interior protrusion surface 151, a protrusion passageway 152 that extends through each protrusion 150 along the longitudinal direction Z, and a protrusion substrate 153. The plurality of protrusions 150, as shown in FIGS. 1-2, 4, 10, and 12, each have portions that are the first jacket portion 100 and the second jacket portion 110. The plurality of protrusions 150 also have the draw string compressive element 120. In another embodiment the compressive element 120 may be any type of device known by one of ordinary skill in the art that allows the user to exert a compressive force on the plurality of protrusions 150 and the CU Pipes 2 as described below.

As shown in FIGS. 1-2, 4, 10, and 12 the plurality of protrusions 150 are made of a fabric material. In the present embodiment the plurality of protrusions 150 are silicone impregnated fiberglass cloth. In various other embodiments the plurality of protrusions 150 may be any fabric material or any other material known to those of ordinary skill in the art that allows the elements to function as described herein.

The plurality of protrusions 150 of the present embodiment are formed of two sheets of the fabric material in the same way as the jackets 20,30,40 as described above. In various other embodiments the plurality of protrusions 150 may be formed of any number of sheets of fabric material or any other material known to those of ordinary skill in the art that allows the elements to function as described herein.

As shown in FIGS. 1-2, 10 and 12, the protrusion substrate 153 is attached to the protrusion interior surface 153 with an adhesive. In various other embodiments the protrusion substrate 153 may be removably attached or fixedly attached to the any surface of the plurality of protrusions 150 by a chemical weld, a seam, or any other way known by one of ordinary skill in the art that allows the elements to function as described herein. The protrusion substrate 153 is an insulative material. In the present embodiment the protrusion substrate 153 is a closed-cell elastomeric foam. In various other embodiments the protrusion substrate 153 may be any insulative material, sound dampening material, fireproof material, and/or fire resistant material known to those of ordinary skill in the art that allows the elements to function as described herein. For example, in the various other embodiments, the protrusion substrate 153 may be a mass-loaded vinyl, a woven fiberglass, or a stainless steel foil.

As shown in FIGS. 1-2, 10 and 12, the plurality of protrusions 150 of the present embodiment are flexible and attach to the front protrusion jacket surface 31 of the protrusion jacket 30, for example, with a seam. In another embodiment the plurality of protrusions 150 are an integrated part of the protrusion jacket 30. In various other embodiments the plurality of protrusions 150 are attached to any surface of the jackets 20,30,40 in any way known to one of ordinary skill in the art that allows the elements to function as described herein.

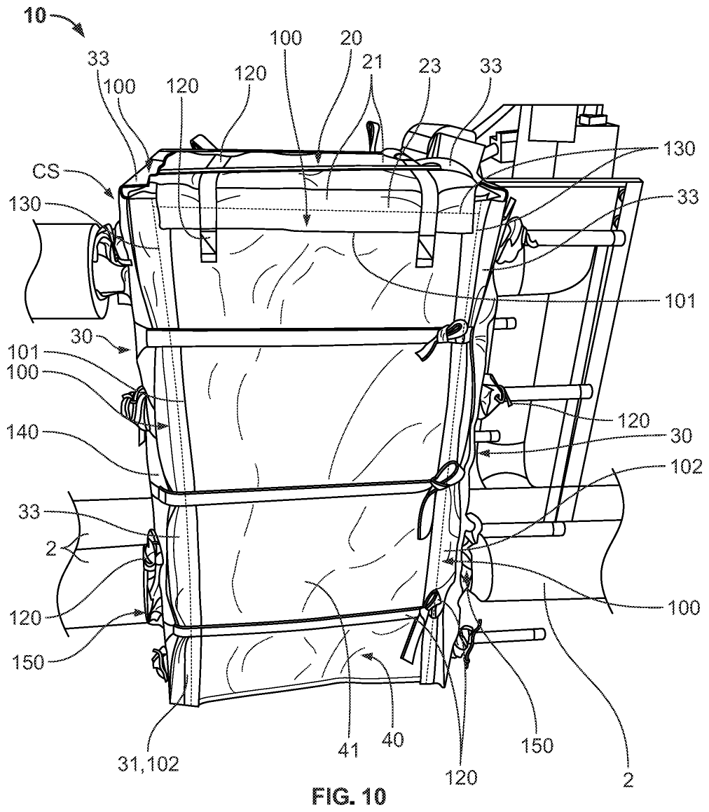

Operational aspects of the removable cover 10 are now described with reference to FIGS. 10-12.

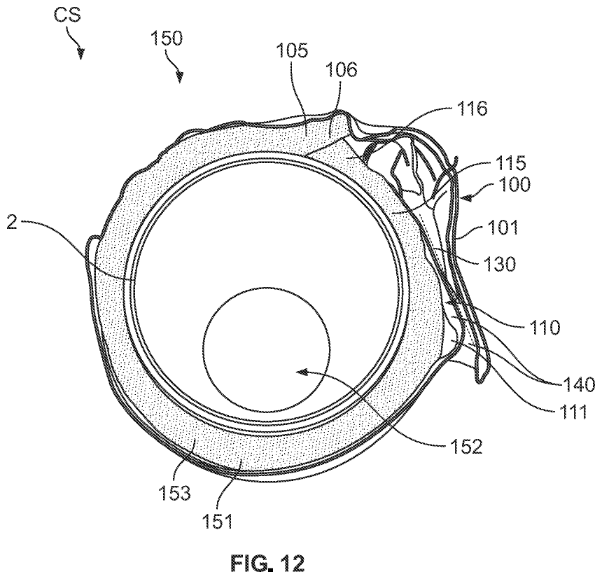

As shown in FIGS. 10 and 12, the jackets 20,30,40 cover the coverable unit 1 and the plurality of protrusions 150 cover the CU Pipes 2.

First, as shown in FIG. 10, the protrusion jackets 30 are placed on the sides of the coverable unit 1 with the CU Pipes 2. The protrusion jacket back surface 32 and the protrusion jacket substrate 34 face the coverable unit 1. Second, as shown in FIG. 10, the nonprotrusion jackets 40 are placed on the sides of the coverable unit 1 without the CU Pipes 2. The nonprotrusion jacket back surface 42 and the nonprotrusion jacket substrate 44 face the coverable unit 1. The nonprotrusion jacket substrate 44 that is on the nonprotrusion jacket edges 43 abuts the protrusion jacket substrate 33 that is on the protrusion jacket edges 33.

Once the jackets 30,40 are placed on the coverable unit 1 they are attached to one another as follows: (1a) the first jacket portion end 101 of the protrusion jacket 30 overlaps the second jacket portion end 111 of the nonprotrusion jacket 40; (2a) the respective plurality of fasteners 140 located on the first jacket portion 100 of the protrusion jacket 30 and the second jacket portion 110 of the nonprotrusion jacket 40 are then placed in contact with one another and removably attach the protrusion jacket 30 to the nonprotrusion jacket 40 at a respective joint 130 of the removable cover, as shown in FIGS. 10-11; (3a) steps 1a and 2a are then repeated every time jacket edges 33,43 of the jackets 30,40 meet one another.

Once the jackets 30,40 are attached to one another and the coverable unit 1 as described in steps 1a-3a above the top jacket 20 is placed on the coverable unit 1 as follows: (1b) the top jacket 20 is placed on the top of the coverable unit 1 and the top jacket substrate 24 abuts the jacket substrates 34,44; (2b) the first jacket portion end 101 of the protrusion jacket 30 overlaps the second jacket portion end 111 of the top jacket 20; (3b) the respective plurality of fasteners 140 located on the first jacket portion 100 of the protrusion jacket 30 and the second jacket portion 110 of the top jacket 20 are then placed in contact with one another and removably attach the protrusion jacket 30 to the top jacket 20 at a respective joint 130 of the removable cover, as shown in FIGS. 10-11; (4b) the first jacket portion end 101 of the top jacket 20 overlaps the second jacket portion end 111 of the nonprotrusion jacket 40; (5b) the respective plurality of fasteners 140 located on the top jacket portion 100 of the top jacket 20 and the second jacket portion 110 of the nonprotrusion jacket 40 are then placed in contact with one another and removably attach the top jacket 20 to the nonprotrusion jacket 40 at a respective joint 130 of the removable cover, as shown in FIGS. 10-11; (6b) steps 2b-5b are repeated every time jacket edges 33,23 and 23,43 of the jackets 30,20 and 20,40 meet one another.

Steps 1a-3a and 1b-6b are completed in a noncompressed state (hereinafter the “NCS”). When the removable cover 10 is in the NCS there is an air gap between the jackets 20,30,40 and the coverable unit 1. The air gap is made smaller when the removable cover 10 changes from the NCS to the CS. In order to make the air gap smaller, the compressive elements 120 are engaged to transition the removable cover 10 from the NCS to the CS as follows: (1c) after steps 1a-3a and 1b-6b are completed the cinch strap compressive elements 120 are engaged by the user to create a compressive force on each respective joint 130, thus transitioning the removable cover 10 from the NCS to the CS and thereby making the size of the air gap smaller.

After step 1c is completed, each protrusion 150 is removably attached to each respective CU Pipe 2 as follows: (1d) a respective CU Pipe 2 is placed through and/or into a respective protrusion passageway 152 of a respective protrusion 150 of the plurality of protrusions 150; (2d) the first jacket portion end 101 of the protrusion 150 overlaps the second jacket portion end 111 of the protrusion 150 and the first substrate portion end 106 of the protrusion 150 overlaps the second substrate portion end 116 of the protrusion 150; (3d) the respective plurality of fasteners 140 located on the first jacket portion 100 of the protrusion 150 and the second jacket portion 110 of the protrusion 150 are then placed in contact with one another and removably attach the first jacket portion 100 and the second jacket portion 110 of the protrusion 150 to one another and the CU Pipe 2 at a respective joint 130 of the removable cover, as shown in FIGS. 12; and (4d) steps 1d-3d are repeated for each protrusion 150 that is attached to the protrusion jacket 30.

Steps 1d-4d are completed in the NCS. When each protrusion 150 is in the NCS there is an air gap between each protrusion 150 and the CU Pipes 2. The air gap is made smaller when each protrusion 150 changes from the NCS to the CS. In order to make the air gap smaller the compressive elements 120 are engaged to transition each protrusion 150 from the NCS to the CS as follows: (1e) after steps 1d-4d are completed the draw string compressive elements 120 are engaged providing a compressive force on each respective joint 130, thus transitioning each protrusion 150 from the NCS to the CS and thereby making the size of the air gap smaller. Each protrusion 150 has an approximately cylindrical shape in the CS due to the cylindrical shape of the CU Pipes 2. In various other embodiments each protrusion 150 of the plurality of protrusions 150 in the CS may have an approximately rectangular shape, an approximately square shape, and approximately hexagonal shape, or any other shape known to one of ordinary skill in the art to accommodate different shaped CU Pipes and or other elements of different coverable units.

When the removable cover 10 is used to cover the coverable unit 1, the compressive elements 120 are engaged by the user to make the size of the air gap between the removable cover 10 and the coverable unit 1 smaller in the CS. Thus, because the removable cover 10 can make the size of the air gap smaller in the CS, the potential for water seepage, frost, and/or corrosion is decreased, thereby making using the removable cover 10 adequate for insulating the coverable unit 1 in low temperature applications. Likewise, the decrease in the size of the air gap allows the removable cover 10 to be used to provide a more efficient seal or barrier in other applications, such as sound isolation and fire proofing.

What is claimed is:

1. A removable cover comprising:
a first jacket portion having a first jacket portion end;
a first substrate portion attached to the first jacket portion and having a first substrate portion end;
a second jacket portion having a second jacket portion end;
a second substrate portion attached to the second jacket portion and having a second substrate portion end; and
a compressive element attached to the first jacket portion and the second jacket portion, the first jacket portion end overlaps the second jacket portion end at a joint of a plurality of joints of the removable cover in a compressed state of the removable cover, the compressive element provides a compressive force on the joint in the compressed state.

2. The removable cover of claim 1, wherein the first substrate portion end overlaps the second substrate portion end at the joint of the plurality of joints of the removable cover in the compressed state of the removable cover.

3. The removable cover of claim 1, wherein a size of an air gap between the removable cover and a coverable unit is smaller in the compressed state than in an uncompressed state.

4. The removable cover of claim 3, wherein the compressive element is a cinch strap or a draw string.

5. The removable cover of claim 1, wherein a plurality of fasteners are attached to the first jacket portion end and the second jacket portion end.

6. The removable cover of claim 5, wherein the plurality of fasteners are hook and loop fasteners.

7. The removable cover of claim 6, wherein the plurality of hook and loop fasteners removably attach the first jacket portion and the second jacket portion at the joint of the plurality of joints of the removable cover.

8. The removable cover of claim 1, wherein the first jacket portion and the second jacket portion are a fabric material.

9. The removable cover of claim 8, wherein the fabric material is a silicone impregnated fiberglass cloth.

10. The removable cover of claim 1, wherein the first substrate portion and the second substrate portion are one of: an insulative material, a sound dampening material, a fire-resistant material, or a fireproof material.

11. The removable cover of claim 10, wherein the first substrate portion and the second substrate portion are one of: a closed cell elastomeric foam, a mass-loaded vinyl, woven fiberglass, or a stainless steel foil.

12. The removable cover of claim 1, wherein the first substrate portion and the second substrate portion are respectively attached to the first jacket portion or the second jacket portion with a chemical weld, an adhesive, or a stitching.

13. The removable cover of claim 1, wherein a plurality of protrusions are attached to a protrusion jacket of the removable cover.

14. The removable cover of claim 13, wherein the plurality of protrusions have a first jacket portion and a second jacket portion.

15. The removable cover of claim 14, wherein in the compressed state each protrusion of the plurality of protrusions have one of: an approximately circular shape, an approximately rectangular shape, an approximately square shape, or an approximately hexagonal shape.

16. A removable cover system comprising:
a coverable unit being coverable by the removable cover in a noncompressed state; and
the removable cover comprising:
a first jacket portion having a first jacket portion end;
a first substrate portion attached to the first jacket portion and having a first substrate portion end;
a second jacket portion having a second jacket portion end;
a second substrate portion attached to the second jacket portion and having a second substrate portion end; and
a compressive element attached to the first jacket portion and the second jacket portion, the first jacket portion end overlaps the second jacket portion end at a joint of a plurality of joints of the removable cover in a compressed state of the removable cover, the compressive element provides a compressive force on the joint in the compressed state.

17. The removable cover system of claim 16, wherein a size of an air gap between the removable cover and the coverable unit is smaller in the compressed state than in the uncompressed state.

18. The removable cover system of claim 16, wherein the first substrate portion end overlaps the second substrate portion end at the joint of the plurality of joints of the removable cover in the compressed state of the removable cover.

19. The removable cover system of claim 16, wherein the first jacket portion end and the second jacket portion end each have a plurality of hook and loop fasteners.

20. The removable cover system of claim 19, wherein the plurality of hook and loop fasteners removably attach the first jacket portion end and the second jacket portion end at the joint of the plurality of joints of the removable cover.
